(19) United States
(12) Patent Application Publication
(10) Pub. No.: US 2018/0111311 A1
(43) Pub. Date: Apr. 26, 2018

(54) FORMING APPARATUS AND FORMING METHOD

(71) Applicant: MIMAKI ENGINEERING CO., LTD., Nagano (JP)

(72) Inventor: Kazuhiro OCHI, Nagano (JP)

(21) Appl. No.: 15/728,200

(22) Filed: Oct. 9, 2017

(30) Foreign Application Priority Data
Oct. 20, 2016 (JP) 2016-205929

(51) Int. Cl. B29C 64/112; B29C 41/22; B29C 64/209; B41J 3/407

(52) U.S. Cl. CPC B29C 64/112; B29C 41/22; B33Y 30/00; B41J 3/4073; B29C 64/209

(57) ABSTRACT

A forming apparatus is configured to form a three-dimensional object, and includes an extrusion head, The extrusion head includes a basic-color extrusion head and a lighter-color extrusion head. The basic-color extrusion head is configured to extrude a basic-color build material having a basic color for expressing a mixed color. The lighter-color extrusion head is configured to extrude a lighter-color build material having a color lighter than the basic-color build material extruded from the basic-color extrusion head.

### CROSS-REFERENCE TO RELATED APPLICATIONS

The present application claims priority under 35 U.S.C. § 119 to Japanese Patent Application No. 2016-205929, filed Oct. 20, 2016. The contents of this application incorporated herein by reference in their entirety.

### BACKGROUND

### Field of the Invention

The present invention relates to a forming apparatus and a forming method.

### Discussion of the Background

JP2015-71282A1 discloses a forming apparatus (3D printer) that forms an object using an ink-jet head. The forming apparatus forms the object by additive manufacturing, that is, by depositing a plurality of layers of ink formed by the ink-jet head.

The contents of JP2015-71282A1 are incorporated herein by reference in their entirety.

A study of a forming method using a forming apparatus has recently been conducted seeking to form a colored object. In this case, for example, regions visually recognizable as colored are colored using a plurality of coloring inks of different colors. Thus, an object colored in a wide variety of colors is formed.

Also in this case, a wide variety of colors using a plurality of coloring inks of different colors can be expressed by, for example, applying the way a wide variety of colors are expressed using an ink-jet printer for printing a two-dimensional image. It is necessary, at the same time, to take into consideration those respects in which coloring an object during its formation is different from printing a two-dimensional image. In light of the above circumstances, there has been a need for forming a colored object by a more suitable method. It is an object of the present disclosure to provide a forming apparatus and a forming method that solves the above-described problems.

The inventor conducted extensive research and study of a more suitable coloring method in the formation of a colored object. In the research and study, the inventor focused on a relationship between the original color of ink used as build material and a manner of coloring at the time of formation. As used herein, the original color of ink refers to the color of ink without coloring material such as pigment and dye being added. The original color of ink can also be considered as the color of a colorless and transparent clear ink. More specifically, when, for example, ultraviolet curable ink is used as build material, the original color of ink can be considered as the original color of a curable component, instead of the original color of the coloring material.

Ideally, the original color of ink is completely colorless and transparent. It is, however, difficult to make the original color of ink completely colorless and transparent in actual situations. Thus, the original color of ink cannot usually be completely colorless and transparent. More specifically, when, for example, ultraviolet curable ink is used, the original color of the ink can be slightly yellowish under the influence of the color of initiator and the color of ultraviolet curable resin contained in the ink.

In this respect, in two-dimensional image printing, the original color of ink does not pose as serious a problem. This is because in two-dimensional image printing, the layer of ink formed on a medium is too thin to make the original color of ink influential.

In forming a three-dimensional object, however, it is necessary to color three-dimensional surfaces more reliably. Specifically, the layers of ink constituting regions formed using coloring inks (colored regions) are usually thicker than the layer of ink in printing a two-dimensional image. This makes the original color of ink more influential in forming a three-dimensional object than in printing a two-dimensional image. This also can cause such a situation that in coloring a colored region in light color, a desired color may not necessarily be obtained because of the influence of the original color of ink. More specifically, when, for example, an ultraviolet curable ink whose original color is yellow is used to express light blue color or similar color, it is possible that the resulting color takes a greenish hue due to a yellowish effect.

In light of the circumstances, the inventor conceived of using a lighter color ink in addition to basic color inks used as coloring inks so as to eliminate or minimize the influence of the original color of ink. Thus, the inventor has found that formation performed in this manner enables a colored object to be formed by a more suitable method. The inventor conducted further extensive research and study to find features necessary for this effect, which has led to the present invention.

### SUMMARY

According to one aspect of the present disclosure, a forming apparatus is configured to form a three-dimensional object, and includes an extrusion head. The extrusion head includes a basic-color extrusion head and a lighter-color extrusion head. The basic-color extrusion head is configured to extrude a basic-color build material having a basic color for expressing a mixed color. The lighter-color extrusion head is configured to extrude a lighter-color build material having a color lighter than the basic-color build material extruded from the basic-color extrusion head.

A non-limiting example of the lighter color is a light color. A non-limiting example of the light color is a color having a high level of light transmittance through a layer having a predetermined thickness.

With this configuration, the lighter-color extrusion head extrudes, for example, a lighter color build material (such as ink). Using a lighter color build material appropriately prevents the original color of the build material from being influenced. This configuration also ensures that a colored object is formed by a more suitable method.

A non-limiting example of the build material is a build material curable under ultraviolet light. As used herein, the build material curable under ultraviolet light refers to a material containing a curable component that is curable under ultraviolet light. A non-limiting example of the colored build material is a material containing a curable component and a coloring material, which is a color component. Examples of the coloring material include, but are not limited to, pigment and dye. A non-limiting example of the basic-colored build material is a material containing a curable component and a basic-color coloring material.

When this build material is used, the color of the build material without any coloring material added can be considered as the original color of the build material. The original color can also be considered as the original color of the curable component contained in the build material. In this case, a non-limiting example of the lighter-colored build material extruded from the lighter-color extrusion head is a material having a color that minimizes the influence of the original color of the curable component.

As used herein, the lighter color that minimizes the influence of the original color of the curable component refers to such a color that when the lighter color and the original color of the curable component are combined with each other, the influence of the original color of the curable component becomes less visually recognizable. When, for example, build materials of a plurality of different lighter colors are used, the lighter color that minimizes the influence of the original color of the curable component may refer to such a color that when the plurality of lighter colors are combined with the original color of the curable component, the influence of the original color of the curable component becomes less visually recognizable. In order to make the influence of the original color of the curable component less visually recognizable, it is possible to use a lighter-color build material or a plurality of lighter-color build materials exhibiting a color that makes a complementary color pair with the original color of the curable component or a color similar to the color that makes a complementary color pair with the original color of the curable component.

The extrusion head may be an ink-jet head configured to extrude the build materials by an inkjet method. In this case, each build material may be a formation-purpose ink, for example. A non-limiting example of such build material is an ultraviolet curable ink, which is curable under ultraviolet light. When an ultraviolet curable ink is used as the build material, the original color of the build material may possibly have a yellowish color. In this case, the lighter color of one build material or the plurality of lighter colors of build materials may be blue color, which makes a complementary color pair with yellow color, or a color similar to the blue color.

In this configuration, the basic-color extrusion head may include a plurality of basic-color extrusion heads configured to extrude basic-color build materials of different colors. In this case, the plurality of basic-color extrusion heads may include a yellow-basic-color extrusion head, a magenta-basic-color extrusion head, a cyan-basic-color extrusion head, and a black-basic-color extrusion head. The yellow-basic-color extrusion head is configured to extrude a yellow-basic-color build material colored in yellow (Y color). The magenta-basic-color extrusion head is configured to extrude a magenta-basic-color build material colored in magenta color (M color). The cyan-basic-color extrusion head is configured to extrude a cyan-basic-color build material colored in cyan color (C color). The black-basic-color extrusion head is configured to extrude a black-basic-color build material colored in black color (K color).

The lighter-color build material extruded from the lighter-color extrusion head may be identical in color to at least one basic-color build material among the basic-color build materials extruded from the plurality of basic-color extrusion heads and may be thinner in color than the at least one basic-color build material. In this case, examples of the lighter-color build material extruded from the lighter-color extrusion head include, but are not limited to, a light magenta build material and a light cyan build material. Alternatively, the lighter-color build material extruded from the lighter-color extrusion head may be a colored build material having a color different from any colors of the build materials extruded from the plurality of basic-color extrusion heads. In this case, the lighter-color build material extruded from the lighter-color extrusion head may be a build material having a light blue color.

The lighter-color build material extruded from the lighter-color extrusion head may be used to compensate for a difference that may occur in a total amount of the basic-color build materials extruded from the plurality of basic-color extrusion heads during formation of a colored region of the object. As used herein, the difference in a total amount of the basic-color build materials extruded from the plurality of basic-color extrusion heads refers to a difference of a total amount of the basic-color build materials in each portion of the colored region and is caused by difference in colors used in each portion.

The extrusion head may further include a transparent-material extrusion head configured to extrude a transparent build material having substantially no color In this case, a build material “having substantially no color” refers to a build material in which no coloring material is added intentionally. In this case, in addition to the lighter-color extrusion head, the transparent-material extrusion head may be used to compensate for the difference in a total amount of the basic-color build materials extruded from the plurality of basic-color extrusion heads. A non-limiting example of the transparent build material having substantially no color is a colorless and transparent clear ink.

The depth of color of the colored region may vary from portion to portion in a normal direction, which is orthogonal to the surface of the object. In this case, for example, the inner portion of the object may preferably be deeper in color than an outer portion of the object. Thus, the outer portion of the object, which is more visually recognizable as having granular texture, is made thinner in color. This configuration eliminates or minimizes granular texture. Also, the inner portion of the object, which is less visually recognizable as having granular texture, is made deeper in color. This configuration makes the colored. region as a whole deeper in color suitably and sufficiently while preventing the colored region from being larger in thickness.

The above-described features can also be implemented in a forming method. This provides similar advantageous effects to the advantageous effects provided by the above-described forming apparatus.

The above-described embodiments enable a colored object to be formed by a more suitable method.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1A illustrates an exemplary configuration of main components or elements of a forming apparatus 10 according to an embodiment of the present disclosure;

FIG. 1B illustrates an exemplary configuration of a head 12 of the forming apparatus 10;

FIG. 1C illustrates an exemplary configuration of an object 50, which is formed by the forming apparatus 10;

FIG. 2A illustrates an exemplary compensation operation, using clear ink, for a change in the amount of coloring ink;

FIG. 2B illustrates an exemplary compensation operation performed in this embodiment;

FIG. 3A illustrates an exemplary configuration of the colored region 204 in which the depth of color varies from portion to portion in the normal direction;

FIG. 3B is a cross-sectional view of an exemplary configuration of another portion of the colored region 204 in which the depth of color varies from portion to portion in the normal direction;

FIG. 3C illustrates an exemplary configuration of the colored region 204 in which the colored region 204 is divided into a larger number of portions;

FIG. 4A illustrates an exemplary configuration of the head 12 in a modified configuration of the forming apparatus 10 in which the head 12 is different from the head 12 illustrated in FIG. 1B; and

FIG. 4B illustrates another modified configuration of the head 12.

### DESCRIPTION OF THE EMBODIMENTS

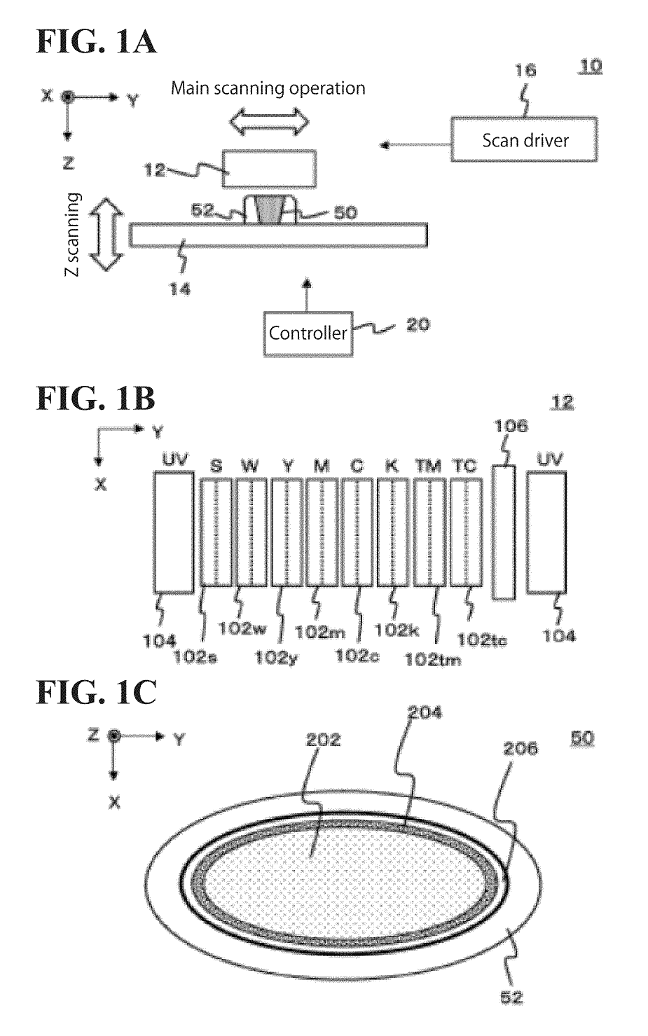

The embodiments will now be described with reference to the accompanying drawings, wherein like reference numerals designate corresponding or identical elements throughout the various drawings. FIG. 1A illustrates an exemplary configuration of main components or elements of the forming apparatus 10.

Except for the respects specified below, the forming apparatus 10 may have a configuration same as or similar to configurations of known forming apparatuses or devices. More specifically, except for the respects specified below, the forming apparatus 10 may have a configuration same as or similar to configurations of known forming apparatuses or devices that use ink-jet heads to extrude droplets (ink droplets) of build material of an object. In addition to the illustrated configurations, the forming apparatus 10 may include any of various other configurations necessary for formation, coloring, and/or other operations associated with the object 50.

In this embodiment, the forming apparatus 10 is a forming apparatus (3D printer) that forms the three-dimensional object 50 by additive manufacturing. As used herein, the additive manufacturing refers to a method of forming the object 50 by depositing a plurality of layers. The object 50 refers to a three-dimensional structure. Also in this embodiment, the forming apparatus 10 includes the head 12, a platform 14, a scan driver 16, and a controller 20.

The head 12 extrudes build material of the object 50. In this embodiment, the build material of the object 50 is an ink. As used herein, the ink refers to a liquid extruded from the ink-jet head. Also as used herein, the ink jet head refers to an extrusion head that extrudes droplets of ink by ink jet technology.

More specifically, from a plurality of ink-jet heads, the head 12 extrudes, as the build material of the object 50, an ink curable under a predetermined condition(s). Then, the extruded ink is cured. In this manner, layers constituting the object 50 are deposited upon one another. The ink used in this embodiment is ultraviolet curable ink (UV ink), which turns from liquid state to solid state under ultraviolet light. Thus, the ultraviolet curable ink is a non-limiting example of the build material curable under ultraviolet light recited in the appended claims. As used herein, the build material curable under ultraviolet light refers to a material containing a curable component that is curable under ultraviolet light.

The head 12 also extrudes build material of the support layer 52, in addition to the build material of the object 50. With this configuration, the forming apparatus 10 forms, as necessary, the support layer 52 around the object 50. As used herein, the support layer 52 refers to a multilayer structure surrounding and supporting the object 50 being formed. The support layer 52 is formed as necessary during formation of the object 50, and is removed after the object 50 is formed. A specific configuration of the head 12 will be described in more detail later.

The platform 14 is a pedestal-shaped member for supporting the object 50 being formed, and is located at a position to face the ink-jet heads of the head 12. The object 50 being formed is placed on the upper surface of the platform 14. In this embodiment, at least the upper surface of the platform 14 is movable in the deposition direction (the Z direction in the drawings). With this configuration, the platform 14 is driven by the scan driver 16 to move at least the upper surface of the platform 14 as the formation of the object 50 progresses. As used herein, the deposition direction refers to the direction in which build. material is deposited in an additive manufacturing process. More specifically, in this embodiment, the deposition direction refers to a direction orthogonal to the main scanning direction (the Y direction in the drawings) and the sub-scanning direction (the X direction in the drawings).

The scan driver 16 causes the head 12 to perform a scan operation, which is to move relative to the object 50 being formed. As used herein, to move relative to the object 50 being formed refers to moving relative to the platform 14. The scan driver 16 also causes the head 12 to perform a main scanning operation (Y scanning), a sub-scanning operation (X scanning), and a deposition direction scanning (Z scanning).

As used herein, to cause the head 12 to perform a main scanning operation refers to causing the ink-jet heads of the head 12 to perform the main scanning operation. Also, the main scanning operation refers to an operation to extrude ink while moving in the main scanning direction. In the main scanning operation, the scan driver 16 causes the head 12 to move with the position of the platform 14 in the main scanning direction fixed. In a modified configuration of the forming apparatus 10, the scan driver 16 may cause the platform 14 to move with the position of the head 12 in the main scanning direction fixed so as to cause the object 50 to move.

As described in more detail later, in this embodiment, the head 12 includes an ultraviolet (UV) light source. In the main scanning operation, the scan driver 16 drives the ultraviolet light source of the head 12. More specifically, the scan driver 16 turns the UV light source on during the main scanning operation so as to cure the ink hitting the build surface of the object 50. As used herein, the build surface of the object 50 refers to the surface on which a next layer of ink is to be formed by the head 12.

As used herein, to cause the head 12 to perform a sub-scanning operation refers to causing the ink-jet heads of the head 12 to perform the sub-scanning operation. Also, the sub-scanning operation refers to an operation to move relative to the platform 14 in the sub-scanning direction, which is approximately orthogonal to the main scanning direction. More specifically, the sub-scanning operation refers to an operation to move relative to the platform 14 in the sub-scanning direction by a forwarding amount set in advance.

In this embodiment, the scan driver 16 causes the head 12 to perform the sub-scanning operation between main scanning operations. In this case, the scan driver 16 causes the platform 14 to move with the position of the head 12 in the sub-scanning direction fixed so as to cause the head 12 to perform the sub-scanning operation. Alternatively, the scan driver 16 may cause the head 12 to move with the position of the platform 14 in the sub-scanning direction fixed so as to cause the head 12 to perform the sub-scanning operation. The scan driver 16 causes the head 12 to perform the sub-scanning operation only as necessary, depending on the size of the object 50 to be formed. Specifically, when, for example, the object 50 to formed is small in size, a sub-scanning operation may not necessarily be performed in forming the object 50.

As used herein, to cause the head 12 to perform a deposition direction scanning refers to causing the ink-jet heads of the head 12 to perform the deposition direction scanning. Also, the deposition direction scanning refers to an operation to cause at least one of the head 12 and the platform 14 to move in the deposition direction so as to cause the head 12 to move in the deposition direction relative to the object 50. As used herein, to cause the head 12 to move in the deposition direction refers to causing at least the ink-jet heads of the head 12 to move in the deposition direction. Also as used herein, to cause the platform 14 to move in the deposition direction refers to causing at least the upper surface of the platform 14 to move.

The scan driver 16 also causes the head 12 to perform the deposition direction scanning as the formation operation progresses so as to adjust the position of the ink-jet heads in the deposition direction relative to the object 50 being formed. More specifically, in this embodiment, the scan driver 16 causes the platform 14 to move with the position of the head 12 in the deposition direction fixed. Alternatively, the scan driver 16 may cause the head 12 to move with the position of the platform 14 in the deposition direction fixed.

A non-limiting example of the controller 20 is a central processing unit (CPU) of the forming apparatus 10, The controller 20 controls the elements of the forming apparatus 10 so as to control the operation to form the object 50. More specifically, the controller 20 controls the elements of the forming apparatus 10 based on, for example, shape information of the object 50 to be formed and color image information. This configuration of the embodiment ensures that the colored object 50 is formed appropriately.

Next, a more specific configuration of the head 12 will be described. FIG. 1B illustrates an exemplary configuration of the head 12 of the forming apparatus 10. In this embodiment, the head 12 includes a plurality of ink-jet heads. Each of the ink-jet heads includes a nozzle array on a surface of the ink jet head facing the platform 14. The nozzle array includes a plurality of nozzles aligned in a predetermined nozzle array direction. The forming apparatus 10 extrudes build materials through the plurality of nozzle arrays of the head 12 so as to form the object 50.

As used herein, the nozzle array direction refers to a direction approximately parallel to the sub-scanning direction. The head 12 includes the plurality of ink-jet heads, a plurality of ultraviolet light sources 104, and a flattening roller 106. As illustrated in FIG. 1B, the plurality of an ink-jet heads include an ink-jet head 102s, an ink-jet head 102w, an ink-jet head 102y, an ink-jet head 102m, an ink-jet head 102c, an ink-jet head 102k, an ink-jet head 102tm, and an ink-jet head 102tc. The plurality of ink-jet heads are approximately flush with each other in the sub-scanning direction and aligned in the main scanning direction.

The ink-jet head 102s is an ink-jet head that extrudes the build material of the support layer 52. In this embodiment, the build material of the support layer 52 is an ultraviolet curable ink lower in the degree of ultraviolet-caused curing than the build material of the object 50. With this configuration, the ink-jet head 102s extrudes, from the nozzles of the nozzle array, the ultraviolet curable ink serving as the build material of the support layer 52. A non-limiting example of the build material of the support layer 52 is a known material for support layer purposes.

The ink-jet head 102w is an ink-jet head that extrudes ink of white (W color). Specifically, the ink-jet head 102w extrudes white ink from the nozzles of the nozzle array. The ink-jet head 102w is an exemplary internal formation-purpose head that forms the interior of the object 50. Specifically, the ink-jet head 102w uses white ink to form the inner region constituting the interior of the object 50.

The white ink is an exemplary light-reflecting ink. For example, the white ink is used to form a region of the object 50 having a light-reflecting property (light-reflecting region). The light-reflecting region reflects light externally incident on the object 50 when, for example, a surface of the object 50 is colored in full color representation by subtractive color mixing. As used herein, the full color representation refers to a representation of colors implemented by a combination of process color inks capable of subtractive color mixing. Also in this embodiment, the inner region is formed using white ink so that the inner region also functions as a light-reflecting region.

In a modification of the operation of the forming apparatus 10, the inner region and the light-reflecting region may be separate from each other. In this case, the inner region may be formed using an ink other than white ink. In this respect, the head 12 may further include an ink-jet head and/or an associated element for extruding build material ink (Mo ink) for the inner region. As used herein, the build material ink refers to a formation-dedicated ink used to form the inner region of the object 50. The ink jet head for the build material ink can be considered as an internal formation-purpose head.

The ink-jet head 102y, the ink-jet head 102m, the ink-jet head 102c, and the ink-jet head 102k (hereinafter referred to as ink-jet heads 102y to 102k) are non-limiting examples of the plurality of basic-color extrusion heads configured to extrude basic-colored build materials of different basic colors, Each of the ink-jet heads 102y to 102k extrudes, from the nozzles of the nozzle array, an ink (coloring ink) of one basic color among the plurality of basic colors. As used herein, the coloring-purpose head refers to an extrusion head that extrudes a basic-colored build material used to express a color by color mixing. Also as used herein, the basic color refers to one color process color used in full color representation.

More specifically, in this embodiment, the ink-jet head 102y extrudes an ink of yellow color (Y color). The ink-jet head 102m extrudes an ink of magenta color (M color). The ink-jet head 102c extrudes an ink of cyan color (C color). The ink-jet head 102k extrudes an ink of black color (K color).

In this case, the Y color, the M color, the C color, and the K color are exemplary process colors. Also, the Y color ink, the M color ink, the C color ink, and the K color ink are exemplary coloring-purpose build materials. Among the YMCK color inks, the Y color ink, the M color ink, and the C color ink are exemplary chromatic color inks. The ink-jet heads 102y to 102k, which extrude these color inks, are exemplary coloring ink-jet heads (coloring-purpose heads) used to form the colored object 50.

The ink-jet head 102tm and the ink-jet head 10tc are non-limiting examples of the lighter-color extrusion head. As used herein, the lighter-color extrusion head refers to an extrusion head that extrudes a lighter-color build material having a color lighter than the build material extruded from the basic-color extrusion head. As used herein, the lighter color refers to a light color. As used herein, the light color efers to a color having a high level of light transmittance through a layer having a predetermined thickness.

More specifically, in this embodiment, the ink-jet head 102tm is a non-limiting example of the lighter-magenta-color extrusion head configured to extrude a lighter-magenta-color (lighter color) ink lighter in color than the ink extruded from the ink-jet head 102m, The ink-jet head 102tc is a non-limiting example of the lighter-cyan-color extrusion head configured to extrude a lighter-cyan-color (lighter color) ink lighter in color than the ink extruded from the ink-jet head 102c. Thus, the ink-jet head 102tm extrudes an ink identical in color to and thinner in color than the ink extruded from the ink-jet head 102m, and the ink-jet head 102tc extrudes an ink identical in color to and thinner in color than the ink extruded from the ink-jet head 102c.

A non-limiting example of the ink extruded from the ink-jet head 102tm is an ink which contains the same coloring material contained in the ink extruded from the ink-jet head 102m and in which the coloring material content is lower than the coloring material content in the ink extruded from the ink-jet head 102m. A non-limiting example of the ink extruded from the ink-jet head 102tc is an ink which contains the same coloring material contained in the ink extruded from the ink extruded from the ink-jet head 102c and in which the coloring material content is lower than the coloring material content in the ink extruded from the ink-jet head 102c. Examples of the coloring material include, but are not limited to, coloring pigment and coloring dye. The inks extruded from the ink-jet head 102tm and the ink-jet head 102tc can also be considered as, for example, light-color transparent inks.

In this embodiment, each of the ultraviolet curable inks used as the above-described color inks contains a curable component curable under ultraviolet light and a coloring material, which is a color component. Generally, the curable component is not completely colorless and transparent; instead, the curable component is lightly colored to a degree. More specifically, when ultraviolet curable ink is used as in this embodiment, the original color of the curable component possibly has a slightly yellowish color under the influence of, for example, ultraviolet cure resin and polymerization initiator. In this case, the original color of ink also has a yellowish color. As used herein, the original color of ink refers to a color of an ink without any coloring material added in the ink.

In light of the circumstances, in this embodiment, the inks extruded from the ink-jet head 102tm and the ink-jet head 102tc, which are lighter-color extrusion heads, each have a lighter color that minimizes the influence of the original color of the curable component. As used herein, the lighter color that minimizes the influence of the original color of the curable component refers to such a color that when the lighter color and the original color of the curable component are combined with each other, the influence of the original color of the curable component becomes less visually recognizable. Also, when a plurality of inks of lighter colors are used as in this embodiment, the lighter color that minimizes the influence of the original color of the curable component refers to such a color that when the plurality of lighter colors are combined with the original color of the curable component, the influence of the original color of the curable component becomes less visually recognizable.

More specifically, when the above-described ultraviolet curable ink whose original color is yellowish is used to form and color the object 50, further adding blue color, which makes a complementary color pair with yellow color, or a color similar to the blue color eliminates or minimizes the influence of the original color. For example, in this embodiment, by using the lighter-magenta-color ink extruded from the ink-jet head 102tm and the lighter-cyan-color ink extruded from the ink-jet head 102tc, the magenta color and the cyan color are mixed into a blue color component. This configuration appropriately eliminates or minimizes the yellowish effect in the original color.

In this case, the depth of the lighter magenta color and the depth of the lighter cyan color are preferably set as desired based on the level of yellowishness of the original color of ink. This configuration appropriately eliminates or minimizes the influence of the original color of ink. The inks extruded from the ink-jet head 102tm and the ink-jet head 102tc will be described in more detail later.

The plurality of ultraviolet light sources 104 are optical sources (UV optical sources) that cure ink by radiating ultraviolet light to cure ultraviolet curable ink. One ultraviolet light source 104 of the plurality of ultraviolet light sources 104 is located at one end of the head 12 in the main scanning direction, and the other ultraviolet light source 104 is located at the other end of the head 12 in the main scanning direction. Thus, the plurality of ultraviolet light sources 104 are arranged with the ink-jet head arrays located between the plurality of ultraviolet light sources 104. A non-limiting example of each ultraviolet light source 104 is an ultraviolet light-emitting diode (UVLED). Other examples of the ultraviolet light source 104 include, but are not limited to, a metal halide lamp and a mercury lamp.

The flattening roller 106 is flattening means for flattening layers of ink formed during formation of the object 50. In the main scanning operation, for example, the flattening roller 106 comes into contact with the outermost layer of ink so as to remove part of the ink that is not cured yet.

Using the head 12 with the above-described configuration enables a layer of ink of the object 50 to be appropriately formed. Forming a plurality of layers of ink upon one another enables the object 50 to be appropriately formed.

The above-described specific configuration of the head 12 is not intended in a limiting sense various modifications are possible. For example, the head 12 may further include, as a coloring ink jet head, an ink-jet head for a color other than YMCK. Also, the plurality of ink-jet heads of the head 12 may be arranged in any other manner. For example, some of the ink-jet heads may be displaced relative to other ink-jet heads in the sub-scanning direction.

Another possible modification is that the head 12 includes, as a lighter-color extrusion head, an ink-jet head that extrudes an ink of a light color different from the colors of the inks extruded from the ink-jet head 102tm and the ink-jet head 102tc, in this case, for example, the ink-jet head may extrude an ink having a color different from any of YMCK. Another possible modification is that the head 12 includes, as an ink-jet head that extrudes a transparent ink, an ink-jet head (transparent-material extrusion head) that extrudes a colorless and transparent clear ink, in addition to the ink-jet head 102tm and the ink-jet head 102tc. As used herein, the colorless and transparent ink refers to an ink having substantially no color. Also as used herein, the ink having substantially no color refers to an ink in which no coloring material is added intentionally. A modified configuration of the head 12 will be described in more detail later.

Next, an exemplary configuration of the object 50, which is formed by the forming apparatus 10, will be described. FIG. 1C illustrates an exemplary configuration of the object 50, which is formed by the forming apparatus 10. Specifically, FIG. 1C illustrates a cross-sectional view of an ellipse object 50 together with the support layer 52. As illustrated in FIG. 1C, the illustrated cross-section is an X-Y cross-section, which is perpendicular to the Z direction. A Z-X cross-section of the object 50, which is perpendicular to the Y direction, and a Z-Y cross-section of the object 50, which is perpendicular to the Z direction, are similar in configuration to the X-Y cross-section.

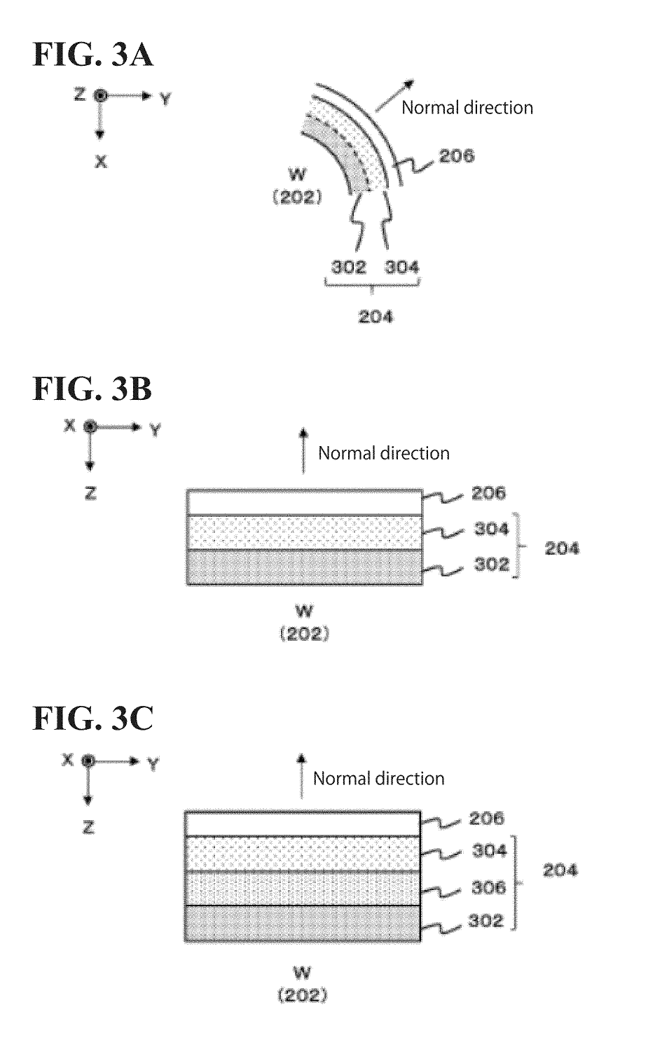

As described above, the head 12 of the forming apparatus 10 according to this embodiment uses the ink-jet heads 102y to 102k, which extrude coloring inks, and other elements to form the object 50 colored on the surface. As used herein, the object 50 colored on the surface means that at least a part of a region of the object 50 visually recognizable as colored is colored. Also as illustrated in FIG. 3C, in this embodiment, when the forming apparatus 10 forms the object 50 colored on the surface, the object 50 includes an inner region 202, the colored region 204, and a protection region 206. As necessary, the support layer 52 is formed around the object 50.

The inner region 202 is an inner region (core portion) shaping the object 50. In this embodiment, the head 12 forms the inner region 202 using white ink extruded from the ink-jet head 102w As described above, the inner region 202 also functions as a light-reflecting region.

The colored region 204 is a region (color layer portion) colored using the coloring inks extruded from the ink-jet heads 102y to 102k. Also, the colored region 204 is a layered region formed along the surface shape of the object 50, as illustrated in FIG. 3C. Also in this embodiment, in addition to the coloring inks extruded from the ink-jet heads 102y to 102k, the head 12 uses the lighter color inks extruded from the ink jet head 102tm and the ink-jet head 102tc to form the colored region 204 around the inner region 202. In this case, the amount of extrusion of each coloring ink is varied from portion to portion of the colored region 204 so as to express a wide variety of colors. The lighter color inks extruded from the ink-jet head 102tm and the ink-jet head 102tc compensate for a change in the amount (amount of extrusion per unit volume) of each coloring ink caused by a difference in color. This configuration ensures that portions of the colored region 204 can be appropriately colored using desired colors. The above configuration also ensures that the formed colored region 204 is appropriately colored using coloring inks. How to compensate for a change in the amount of each coloring ink caused by a difference in color will be described in more detail later.

The protection region 206 is a transparent region that protects the outer surface of the object 50. In this embodiment, the head 12 uses the lighter color inks extruded from the ink-jet head 102tm and the ink-jet head 102tc to form the protection region 206 around the colored region 204. Forming the protection region 206 on the outer surface of the object 50 enables the colored region 204 and other elements to be more appropriately protected.

In this respect, the protection region 206 is preferably substantially colorless and transparent so that the color of the colored region 204 is not influenced. As used herein, being substantially colorless and transparent refers to being considered as colorless and transparent in the accuracy of coloring required in the formation of the object 50. In this et bodiment, using the lighter magenta ink extruded from the ink-jet head 102tm and the lighter cyan ink extruded from the ink-jet head 102tc appropriately eliminates or minimizes the influence of the original color of ink. This configuration ensures that a substantially colorless and transparent region is appropriately formed as the protection region 206.

By forming the regions in the above-described manner, the object 50 colored on the surface is appropriately formed. In a modified configuration of the object 50, the object 50 may have a different configuration. Specifically, a light-reflecting region, as distinguished from the inner region 202, may be formed between the inner region 202 and the colored region 204. In this case, the inner region 202 may be formed using an ink other than white ink. For example, the inner region 202 may be formed using any desired ink other than the build material of the support layer 52. For further example, a separate region may be formed between the light-reflecting region and the colored region 204. As used herein, the separate region refers to a region that prevents the white ink constituting the light-reflecting region from mixing with the coloring ink of the colored region 204. For example, the separate region is formed using the lighter color inks extruded from the ink-jet head 102tm and the ink-jet head 102tc.

Next, how to use the lighter color inks extruded from the ink-jet head 102tm and the ink-jet head 102tc will be described in the context of a compensation operation for a change in the amount of coloring ink in forming the colored region 204. The compensation operation is to compensate for a change in the amount of each coloring ink caused by a difference in color, as described above. In the following description, for convenience of description, a colorless and transparent clear ink, is first used for the compensation operation, instead of using a lighter color ink.

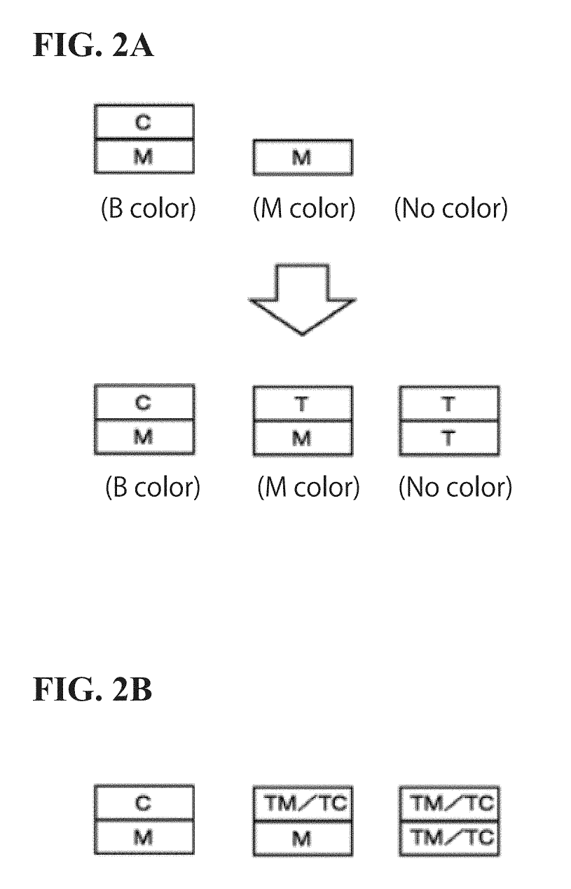

FIG. 2A illustrates an exemplary compensation operation, using clear ink, for a change in the amount of coloring ink.

When a color is expressed by mixing a plurality of coloring inks of different colors, such as the YMCK color inks, one color ink or a plurality of color inks is extruded to each of portions set based on formation resolution. In this manner, a wide variety of colors are expressed. As used herein, extruding a plurality of color inks to each portion refers to, in an operation to form one layer of ink, extruding a plurality of color inks to the same portion set in design viewpoints. In this case, the number of ink droplets hitting each portion is not uniform but varies depending on the color to be used for each portion.

More specifically, assumed that colors are expressed using the YMCK color inks. In this case, when, for example, blue color (B color) is used for coloring, magenta color and cyan color are mixed together to express the B color. Specifically, as the upper left figure in FIG. 2A shows, an M color ink and a C color ink are extruded to one portion. That is, two droplets (ink droplets) of the YMCK color inks hit the portion.

When magenta color (M color) is used for coloring, the color can be expressed without mixing a plurality of colors. Specifically, as the upper middle figure in FIG. 2A shows, an M color ink along is extruded to one portion. That is, one droplet of the YMCK color inks hits the portion.

Also, no YMCK color inks are extruded to a part of the colored region 204 (see FIG. 1) of the object 50 so that the part of the object 50 is not colored (colorless). Specifically, as the upper right figure in FIG. 2A shows, no droplets of the YMCK color inks hit the portion.

Thus, when a color is expressed by mixing a plurality of coloring inks of different colors, the number of droplets of coloring ink to hit each portion varies depending on which color is to be used for each portion. When, however, additive manufacturing is employed, a plurality of layers of ink are deposited upon one another. This configuration causes a difference to occur in the number of ink droplets hitting each portion, making it difficult to perform formation with a high level of accuracy. More specifically, the thickness of a layer of ink becomes uneven, making it difficult for the flattening roller 106 (see FIG. 1) to perform flattening operation appropriately.

In light of the above circumstances, when an object is formed by additive manufacturing, differences in the amount of ink is compensated for as illustrated in the lower half of FIG. 2A using an ink that does not influence the neighboring color. A simplest example of the ink that does not influence the neighboring color is a clear ink, which has no coloring material added therein and thus is theoretically colorless and transparent (T color).

In this case, as illustrated in FIG. 2A, the number of droplets of the clear ink hitting each portion is varied depending on the number of droplets of the YMCK color inks hitting each portion. In this manner, a total of the hitting number of droplets of the YMCK color inks and the hitting number of droplets of the clear ink is adjusted to be constant. This configuration ensures that a change in the amount of each YMCK color ink, which is used as coloring ink, is appropriately compensated for. The above configuration also uniformizes, during the formation operation, the height of the colored region 204 being formed before being flattened by the flattening roller 106. This enables the flattening roller 106 to perform flattening operation more appropriately. As a result, the object 50 is formed with improved accuracy.

In actual situations, however, the original color of ink is influenced, as described above. Thus, when a clear ink is used for compensation operation, as described above, since the original color of the ink is influenced, it is sometimes or often the case that a desired color cannot be appropriately expressed. Also, for example, when a light color is used for coloring, the original color of the ink can be influenced more significantly. Specifically, if, for example, the original color of the ink is yellowish, it is possible that a light bluish hue cannot be sufficiently expressed.

In light of the circumstances, in this embodiment, the lighter color inks extruded from the ink-jet head 102tm and the ink-jet head 102tc (see FIG. 1) are used to compensate for a change in the amount of coloring ink while eliminating or minimizing the influence of the original color of ink. FIG. 2B illustrates an exemplary compensation operation performed in this embodiment.

As illustrated in FIG. 29, in this embodiment, a lighter magenta ink (TM) and a lighter cyan ink (TC) are used, instead of the colorless and transparent clear ink illustrated in FIG. 2A. In this case, a droplet of either a lighter magenta ink or a lighter cyan ink is extruded, instead of one droplet of clear ink illustrated in FIG. 2A. Specifically, in this embodiment, the colored region 204 of the object 50 is colored using the ink-jet heads 102y to 102k (see FIG. 1). At the same time, lighter colored inks are extruded from the ink-jet head 102tm and the ink-jet head 102tc to compensate for a difference in a total amount of the inks extruded from the ink-jet heads 102v to 102k to each portion of the colored region 204.

In this case, a droplet of lighter magenta ink is extruded to some area of a portion of the colored region 204 to be compensate for, and a droplet of lighter cyan ink is extruded to another area of the portion, so that lighter magenta color and lighter cyan color are combined with each other. This combination minimizes the influence of the original color of ink. This configuration appropriately eliminates or minimizes the influence of the original color of ink. The above configuration also ensures that, for example, a light bluish hue is appropriately and sufficiently expressed. As a result, this embodiment ensures that the colored object 50 is formed more appropriately.

In the above description, lighter magenta color and lighter cyan color are mainly used for formation operation, instead of using colorless and transparent clear ink. In a modified configuration of the forming apparatus 10, an ink-jet head for clear ink (transparent-material extrusion head) may be further used for formation operation. In this case, in the operation to compensate for a difference in a total amount of the inks extruded from the ink-jet heads 102y to 102k to each portion of the colored region 204, an ink-jet head for clear ink may be used, in addition to the ink-jet head 1021m and the ink-jet head 102tc.

Also in the above description, lighter magenta ink and lighter cyan ink are used mainly for the purpose of eliminating or minimizing the influence of the original color of ink. These inks may also be used together with, for example, the YMCK color inks for the purpose of expressing colors intentionally. In this case, using light magenta color and/or lighter cyan ink enables more colorful expressions. Also in this case, a light blue color, for example, can be expressed using lighter magenta ink and lighter cyan ink.

In the configuration in which the ink-jet head for clear ink is further used, it is possible to take into consideration the yellowish effect in the original color of the clear ink and to consider the clear ink as an ink having a light yellow color. In this case, by expressing a color by further using a clear ink, each of the Y color ink, the M color ink, and the C color ink is available in a normal density and a lower density. This configuration ensures that more colorful expressions are implemented more appropriately. More specifically, for example, approximately 80% of a color to be expressed may be expressed using basic color inks (the YMCK color inks extruded from the ink-jet heads 102y to 102k), while the remaining approximately 20% of the color may be expressed using a lighter color ink.

When more colorful expressions are sought for using lighter color ink, a simplistic idea may be to use lighter color ink alone, without using normal, basic color ink. However, when lighter color ink alone is used to express a deep color, it is necessary to form a thick layer of ink as the colored region 204, This elongates the distance to the inner region 202 (see FIG. 1), which serves the functions of a light-reflecting region in subtractive mixing, increasing the amount of absorbed light at the colored region 204. This makes the resulting color dark, even though a deep color is obtained. Thus, when lighter color ink alone is used, it may be difficult to appropriately obtain more colorful expressions.

In light of the circumstances, lighter color ink is used in addition to basic color ink. This configuration ensures that a color is expressed appropriately and sufficiently at a portion that is deep in color, without making the thickness of the colored region 204 excessively large. In this case, a lighter color ink colored to a degree may further be used for the above-described compensation operation. This ensures that deeper colors are expressed. Also, using lighter color ink eliminates or minimizes granular texture when light color is used for coloring. Specifically, using inks of at least one color having two or more densities enables more colorful hue expressions to be implemented and minimizes granular texture. Also, colors are expressed in a wider range of densities.

Also, in order to color the colored region 204 with higher quality, it is possible to make the depth of color vary from portion to portion in the normal direction, which is orthogonal to the surface of the object 50, instead of uniformly coloring the entire colored region 204. FIGS. 3A to 3C illustrate an exemplary configuration of the colored region 204 in which the depth of color varies from portion to portion in the normal direction. FIG. 3A is a schematic illustrating an exemplary configuration of the colored region 204. Specifically, FIG. 3A illustrates, together with the inner region 202 and the protection region 206, a cross-section of the colored region 204 approximately orthogonal to the deposition direction.

As described above, if a thick layer of ink is formed as the colored region 204 in the object 50, the expressed color becomes dark, making it difficult to appropriately obtain colorful expressions. In light of the above circumstances, it is necessary to use a coloring ink that is deep in color enough to express a sufficiently deep color whilepreventing the thickness of the colored region 204 from being excessively large. In this case, however, using a deep color ink may make granular texture of a colored surface more visually recognizable.

In light of the circumstances, in the configuration illustrated in FIG. 3A, the depth of color varies from portion to portion in the normal direction, instead of uniformly coloring the entire colored region 204. In this case, in the colored region 204, an inner portion of the object 50 is deeper in color, while an outer portion of the object 50 is thinner in color. That is, the outer portion of the object 50, at which granular texture is more visually recognizable, is thinner in color. This configuration eliminates or minimizes granular texture more appropriately. In this case, granular texture can be reduced to a substantially negligible level (approximately zero). Also, the inner portion, at which granular texture is less visually recognizable, is deeper in color. This configuration makes the entire colored region 204 appropriately and sufficiently deep in color while preventing the thickness of the colored region 204 from being excessively large.

Specifically, the colored region 204 includes an inner region 302 and an outer region 304. The inner region 302 is an inner region of the colored region 204. The outer region 304 is an outer region of the colored region 204. The outer region 304 of the colored region 204 is thinner in color than the inner region 302 of the colored region 204.

In this respect, when in the colored region 204 the inner portion of the object 50 is deeper in color while the outer portion of the object 50 is thinner in color, this may mean that the varied depth of color is employed for at least a part of the colored region 204. The depth of color may be adjusted by, for example, changing the ratio between the coloring inks extruded from the ink-jet heads 102y to 102k (see FIG. 1) and the lighter color inks extruded from the ink jet head 102tm and the ink-jet head 102tc (see FIG. 1). More specifically, the ratio of the inks extruded from the ink-jet head 102tm and the ink-jet head 102tc to each portion of the colored region 204 in the normal direction is defined as lighter-color build material ratio. By varying the lighter-color build material ratio, the depth of color for each portion of the colored region 204 is adjusted. As used herein, the ratio of the inks extruded from the ink-jet head 102tm and the ink-jet head 102tc refers to a ratio to a total amount of inks extruded to each portion of the colored region 204. In the configuration illustrated in FIG. 3A, the lighter-color build material ratio of the outer region 304 of the colored region 204 is larger than the lighter-color build material ratio of the inner region 302 of the colored region 204. Thus, the depth of color is appropriately adjusted for each of the inner region 302 and the outer region 304.

As described above, in the formation of the colored region 204, the lighter magenta ink and the lighter cyan ink can be used not only to compensate for the amount of coloring ink but also to express colors intentionally. For example, the outer region 304, which is thinner in the depth of color, may be colored mainly using the inks extruded from the ink-jet head 102tm and the ink-jet head 102tc. In this case, by adjusting the amount of each of the inks extruded from the ink-jet head 102tm and the ink-jet head 102tc, colors of portions of the outer region 304 are adjusted. Thus, the outer region, at which granular texture is more visually recognizable, is formed using a lighter color ink. This configuration eliminates or minimizes granular texture more appropriately. Also in this case, at least in the formation of the outer region 304, it is preferable to further use a clear ink that has a lighter yellow color. This configuration ensures that more colorful expressions are appropriately obtained using only lighter color inks.

FIG. 3B is a cross-sectional view of an exemplary configuration of another portion of the colored region 204. Specifically, the another portion is a portion at which the normal direction of the object 50 and the deposition direction are parallel to each other. For example, the another portion is an uppermost portion of the object 50 in the deposition direction.

In the formation of the portion illustrated in FIG. 3B, the forming apparatus 10 deposits the inner region 302 and the outer region 304 over the inner region 202 so as to form the colored region 204. Each of the inner region 302 and the outer region 304 is formed by depositing at least one layer of ink. This configuration ensures that the colored region 204, which includes the inner region 302 and the outer region 304, is appropriately formed.

The regions constituting the colored region 204 will not be limited to the two regions, the inner region 302 and the outer region 304; the colored region 204 may include more regions. in this case, at least a part of the colored region 204 preferably becomes deeper in color in the direction toward the inside of the object 50.

FIG. 3C illustrates an exemplary configuration of the colored region 204 in which the colored region 204 is divided into a larger number of portions. In this case, the colored region 204 includes an intermediate region 306, in addition to the inner region 302 and the outer region 304. The intermediate region 306 is formed between the inner region 302 and the outer region 304, Also in this case, the intermediate region 306 is thinner in color than the inner region 302 and deeper in color than the outer region 304. This configuration ensures that the colored region 204 is colored so that the color becomes gradually thinner in the outermost layer direction. This configuration also ensures that the colored region 204 is more naturally colored.

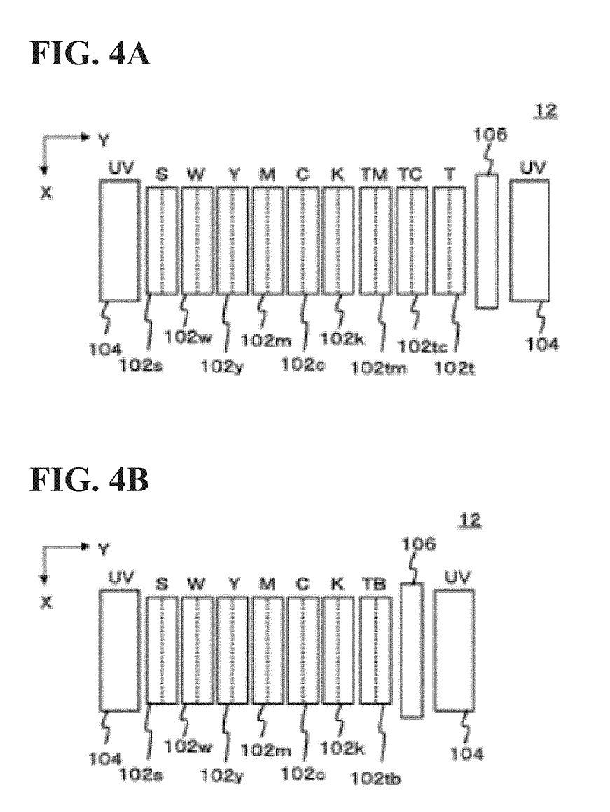

Next, a modified configuration of the forming apparatus 10 will be described, and additional notes on features of the forming apparatus 10 will be provided. FIGS. 4A and 4B illustrate a modified configuration of the forming apparatus 10. Except for the respects specified below, like reference numerals designate corresponding or identical elements throughout FIGS. 1A to 4B.

FIG. 4A illustrates an exemplary configuration of the head 12 in a modified configuration of the forming apparatus 10 in which the head 12 is different from the head 12 illustrated in FIG. 1B. As described above, it is possible to use, as transparent ink for formation use, a colorless and transparent clear ink, other than light color inks. In this case, the head 12 further includes an ink-jet head 102t for clear ink, as illustrated in FIG. 4A. This configuration ensures that more colorful expressions are obtained more appropriately.

In the above description, lighter magenta ink and lighter cyan ink are mainly used as lighter color ink. With this configuration, for example, light magenta color and light cyan color may be mixed together to express light blue color. This appropriately eliminates or minimizes the influence of the original color of ink. The amount of ink extruded to each portion of the colored region 204 can be adjusted more meticulously by adjusting the amount of the lighter magenta ink and the amount of the lighter cyan ink. This configuration also ensures that more colorful expressions are obtained with improved accuracy.

In another modification of the forming apparatus 10, an ink other than lighter magenta color and lighter cyan color may be used as lighter color ink, as described above. In this case, the lighter color ink may be different from any of the basic colors YMCK for coloring use. For example, a light blue color ink may be used.

FIG. 4B illustrates another modified configuration of the head 12. The head 12 includes the ink-jet head 102tm illustrated in FIG. 1B, and in place of the ink-jet head 102tm, includes an ink-jet head 102tb as illustrated in FIG. 4B. The ink-jet head 102tb extrudes light blue ink.

In this case, the blue color is a color that makes a complementary color pair with yellow color. Thus, if the original color of ink is yellowish, using a light blue ink appropriately eliminates or minimizes the influence of the original color. This configuration eliminates or minimizes the influence of the original color of ink and ensures that the colored object 50 is formed more appropriately. Also in this case, the number of necessary ink-jet heads is smaller than when light magenta color and lighter cyan ink are used. This reduces the cost of the forming apparatus 10. In another modification of the head 12, the head 12 may further include, as an ink-jet head for transparent ink, the ink-jet head 102t for clear ink and related elements, in addition to the ink-jet head 102tb.

As used herein, the light blue ink refers to an ink containing a coloring material of light blue color. In this case, under the influence of the color of the coloring material, it is possible that the general color of this ink is a light blue color. Also, in order to minimize the influence of the original color of ink, the color of the light blue ink may be made such a color that the original color of ink and the light blue color of the coloring material are combined to cancel both colors. More specifically, the color of the ink may be faint black resulting from light yellow color and light blue color combining with each other, or may be a color similar to faint black. In this case as well, the ink can be considered as a light blue ink containing a coloring material of light blue color.

Next, additional notes on the configuration of the forming apparatus 10 will be provided. In the above-described configurations, the ink-jet heads for transparent ink (such as the ink-jet head 102tm, the ink-jet head 102tb, ink-jet head 102t, and the ink-jet head 102tb) are located between the flattening roller 106 and the ink-jet heads 102y to 102k. With this configuration, a transparent ink is superposed on the coloring ink (the Y color ink, the M color ink, the C color ink, or the K color ink) in, for example, the main scanning operation of flattening. This ensures that, in the flattening operation using the flattening roller 106, the flattening roller 106 mainly comes into contact with the transparent ink. This also prevents the coloring ink from being displaced by the flattening roller 106. In another modification of the head 12, some or all of the ink-jet heads for transparent ink, depending on the required formation accuracy, may be arranged at some other position than the position between the flattening roller 106 and the ink-jet heads 102y to 102k.

In the above description, the forming apparatus 10 having the configurations illustrated in FIGS. 1A to 3C performs formation operation using lighter magenta ink and lighter cyan ink, in addition to the basic color YMCK inks for coloring use. This feature may seem similar to a configuration of an ink-jet printer for two-dimensional printing using light magenta color and light cyan color.

However, as clearly seen from the above-described description, the forming apparatus 10 having the configurations illustrated in FIGS. 1A to 3C and other drawings uses lighter magenta ink and lighter cyan ink for a unique purpose associated with formation operation. More specifically, an ink-jet printer for two-dimensional printing forms one layer of ink alone to print an image. Since one layer of ink is not a layer-by-layer configuration, in which a large number of layers of ink are deposited upon one another, it is not necessary to compensate for a difference in the amount of coloring ink that may occur when one color changes to another color. Also, with one layer of ink alone, even if the original color of ink is colored to some degree, there is no or a negligible level of influence of the original color.

Contrarily, when the object 50 is formed by additive manufacturing, it is usually necessary to compensate for a difference in the amount of coloring ink that may occur when one color changes to another color, as described above. In this case, the original color of ink used for the compensation operation can pose a problem.

Also, it is necessary to consider that a three-dimensional object 50 will be viewed from wider angles than a two-dimensional image. Also, when there is a small crack or chip on the surface of the object 50. the color of the inner region 202 (see FIG. 1) and other elements inside the colored region 204 (see FIG. 1) should not appear on the surface. In light of the above circumstances, the thickness of the colored region 204 during formation of the object 50 is usually larger than the thickness of a layer of ink of a two-dimensional image. Also, the depth of color of the coloring ink used for the forming apparatus 10 is usually smaller than the depth of color of an ink of the ink-jet printer. More specifically, the depth of color of the coloring ink used for the forming apparatus 10 is closer to the depth of a light color such as light magenta color and light cyan color than to the depth of a normal ink (deep ink) used in the ink-jet printer. As the depth of color of ink is smaller, the original color of ink is more likely to be influenced.

Thus, when the influence of the original color of ink of the object 50 poses a problem, this is linked to unique characteristics of the forming apparatus 10 different from problems observed in two-dimensional image printing. Thus, the above-described features of the forming apparatus 10 are largely different from features of conventional ink-jet printers.

As described above, the depth of color of the coloring ink used for the forming apparatus 10 is closer to the depth of a light ink for ink-jet printers. Thus, an ink having a color lighter than the color of a coloring ink can be considered as an ultra-light color ink as compared with an ink for ink-jet printers.

Also as described above, the protection region 206 is further formed on the outer side of the colored region 204 of the object 50. In this case, there is an influence of the original color of ink of the protection region 206, in addition to the influence of the original color of ink of the colored region 204. Specifically, if the protection region 206 is formed using, for example, a clear ink having a yellowish original color, the influence of the original color is particularly significant. Contrarily, using a lighter color ink such as light magenta color and light cyan color ensures that the protection region 206 is appropriately formed with eliminated or minimized influence of the original color. This configuration also ensures that the colored object 50 is formed more appropriately.

Also as described above, in order to minimize the influence of the original color of ink, it is possible to use an ink colored in a lighter color that minimizes the influence of the original color of the curable component of the ink. As used herein, minimizing the influence of the original color of ink refers to making the color of the mixture of the ink and the original color of the curable component approximately achromatic color. More specifically, for example, when the yellow of the original color of the curable component is mixed by subtractive mixing with magenta. or cyan of lighter color ink, the color of the mixture is black. This may seem that the original color of ink has turned from yellow into black. However, in this case, where the original color has a slight achromatic color such as black, there is presumably a lower level of influence on the color to be expressed, as compared with the case where the original color has a particular chromatic color such as yellow Therefore, the above configuration minimizes the influence of the original color of ink.

The embodiments of the present disclosure can be utilized in, for example, forming apparatuses.

10 . . . Forming apparatus, 12 . . . Head, 14 . . . Platform, 16 . . . Scan driver, 20 . . . Controller, 50 . . . Object, 52 . . . Support layer, 102 . . . Ink-jet head, 104 . . . Ultraviolet light source, 106 . . . Flattening roller, 202 . . . Inner region, 204 . . . Colored region, 206 . . . Protection region, 302 . . . Inner region, 304 Outer region, 306 Intermediate region

What is claimed is:

1. A forming apparatus configured to form a three-dimensional object, the forming apparatus comprising an extrusion head, the extrusion head comprising:
a basic-color extrusion head configured to extrude a basic-color build material having a basic color for expressing a mixed color; and
a lighter-color extrusion head configured to extrude a lighter-color build material having a color lighter than the basic-color build material extruded from the basic-color extrusion head.

2. The forming apparatus according to claim 1,
wherein the extrusion head is an ink-jet head configured to extrude the build materials by an ink-jet method, and
wherein each of the build materials is an ultraviolet curable ink that is curable under ultraviolet light.

3. The forming apparatus according to claim 1,
wherein each of the build materials comprises a curable component that is curable under ultraviolet light, and
wherein the lighter color of the lighter-color build material has a minimal influence on an original color of the curable component.

4. The forming apparatus according to claim 1,
wherein the basic-color extrusion head comprises a plurality of basic-color extrusion heads configured to extrude basic-color build materials of different colors, and
wherein the forming apparatus is configured to:
form the three-dimensional object so that a colored region colored using the basic-color build materials is formed in the three-dimensional object;
color the colored region using the plurality of basic-color extrusion heads; and
when a total amount of the basic-color build materials extruded from the plurality of basic-color extrusion heads is different in each of positions in the colored region, compensate for the difference by causing the lighter-color extrusion head to extrude the lighter-color build material onto each of the positions in the colored region.

5. The forming apparatus according to claim 4,
wherein the extrusion head further comprises a transparent-material extrusion head configured to extrude a transparent build material having substantially no color, and
wherein the forming apparatus is configured to compensate for the difference in the total amount of the basic-color build materials extruded from the plurality of basic-color extrusion heads by causing the transparent-material extrusion head to extrude the transparent build material onto each of the positions in the colored region.

6. The forming apparatus according to claim 4, wherein in at least a part of the colored region, an inner portion of the colored region located at an inner position in a normal direction orthogonal to a surface of the three-dimensional object is deeper in color than an outer portion of the colored region located at an outer position that is outer than the inner position in the normal direction.

7. The forming apparatus according to claim 6, wherein in at least the part of the colored region, the colored region becomes deeper in color in an inner direction of the three-dimensional object

8. The forming apparatus according to claim 6,
wherein at the inner portion and the outer portion of the colored region, a ratio of the lighter-color build material extruded from the lighter-color extrusion head is defined as a lighter-color build material ratio, and
wherein the lighter-color build material ratio at the outer portion is larger than the lighter-color build material ratio at the inner portion.

9. The forming apparatus according to claim 4, wherein the lighter-color build material extruded from the lighter-color extrusion head is identical in color to at least one basic-color build material among the basic-color build materials extruded from the plurality of basic-color extrusion heads and is thinnerin color than the at least one basic-color build material.

10. The forming apparatus according to claim 4, wherein the plurality of basic-color extrusion heads comprise
a yellow-basic-color extrusion head configured to extrude a yellow-basic-color build material colored in yellow (Y color),
a magenta-basic-color extrusion head configured to extrude a magenta-basic-color build material colored in magenta color (M color),
a cyan-basic-color extrusion head configured to extrude a cyan-basic-color build material colored in cyan color (C color), and
a black-basic-color extrusion head configured to extrude a black-basic-color build material colored in black color (K color).

11. The forming apparatus according to claim 10, wherein the lighter-color extrusion head comprises
a lighter-magenta-color extrusion head configured to extrude a lighter-magenta-color build material lighter in color than the magenta-basic-color build material extruded from the magenta-basic-color extrusion head, and
a lighter-cyan-color extrusion head configured to extrude a lighter-cyan-color build material lighter in color than the cyan-basic-color build material extruded from the cyan-basic-color extrusion head.

12. The forming apparatus according to claim 4, wherein the lighter-color build material extruded from the lighter-color extrusion head comprises a color different from the colors of the basic-color build materials extruded from the plurality of basic-color extrusion heads.

13. The forming apparatus according to claim 12,
wherein the plurality of basic-color extrusion heads comprise
a yellow-basic-color extrusion head configured to extrude a yellow-basic-color build material colored in yellow (Y color),
a magenta-basic-color extrusion head configured to extrude a magenta-basic-color build material colored in magenta color (M color),
a cyan-basic-color extrusion head configured to extrude a cyan-basic-color build material colored in cyan color (C color), and
a black-basic-color extrusion head configured to extrude a black-basic-color build material colored in black color (K color), and
wherein the lighter-color build material extruded from the lighter-color extrusion head has a light blue color.

14. A forming method for forming a three-dimensional object using an extrusion head configured to extrude a build material, the extrusion head comprising:
a basic-color extrusion head configured to extrude a basic-color build material having a basic color for expressing a mixed color; and
a lighter-color extrusion head configured to extrude a lighter-color build material having a color lighter than the basic-color build material extruded from the basic-color extrusion head.

15. The forming apparatus according to claim 2,
wherein each of the build materials comprises a curable component that is curable under ultraviolet light, and
wherein the lighter color of the lighter-color build material has a minimal influence on a original color of the curable component.

16. The forming apparatus according to claim 2,
wherein the basic-color extrusion head comprises a plurality of basic-color extrusion heads configured to extrude basic-color build materials of different colors, and
wherein the forming apparatus is configured to:
form the three-dimensional object so that a colored region colored using the basic-color build materials is formed in the three-dimensional object;
color the colored region using the plurality of basic-color extrusion heads; and
when a total amount of the basic-color build materials extruded from the plurality of basic-color extrusion heads is different in each of positions in the colored region, compensate for the difference by causing the lighter-color extrusion head to extrude the lighter-color build material onto each of the positions in the colored region.

17. The forming apparatus according to claim 3,
wherein the basic-color extrusion head comprises a plurality of basic-color extrusion heads configured to extrude basic-color build materials of different colors, and
wherein the forming apparatus is configured to:
form the three-dimensional object so that a colored region colored using the basic-color build materials is formed in the three-dimensional object;
color the colored region using the plurality of basic-color extrusion heads; and
when a total amount of the basic-color build materials extruded from the plurality of basic-color extrusion heads is different in each of positions in the colored region, compensate for the difference by causing the lighter-color extrusion head to extrude the lighter-color build material onto each of the positions in the colored region.

18. The forming apparatus according to claim 5,
wherein the basic-color extrusion head comprises a plurality of basic-color extrusion heads configured to extrude basic-color build materials of different colors, and
wherein the forming apparatus is configured to:
form the three-dimensional object so that a colored region colored using the basic-color build materials is formed in the three-dimensional object;
color the colored region using the plurality of basic-color extrusion heads; and
when a total amount of the basic-color build materials extruded from the plurality of basic-color extrusion heads is different in each of positions in the colored region, compensate for the difference by causing the lighter-color extrusion head to extrude the lighter-color build material onto each of the positions in the colored region.

19. The forming apparatus according to claim 6,
wherein the extrusion head further comprises a transparent-material extrusion head configured to extrude a transparent build material having substantially no color, and
wherein the forming apparatus is configured to compensate for the difference in the total amount of the basic-color build materials extruded from the plurality of basic-color extrusion heads by causing the transparent-material extrusion head to extrude the transparent build material onto each of the positions in the colored region.

20. The forming apparatus according to claim 17,
wherein the extrusion head further comprises a transparent-material extrusion head configured to extrude a transparent build material having substantially no color, and
wherein the forming apparatus is configured to compensate for the difference in the total amount of the basic-color build materials extruded from the plurality of basic-color extrusion heads by causing the transparent-material extrusion head to extrude the transparent build material onto each of the positions in the colored region.
